(19) United States
(12) Patent Application Publication
(10) Pub. No.: US 2014/0038470 A1
(43) Pub. Date: Feb. 6, 2014

(54) PROTECTIVE COVERS FOR CABLE CONNECTORS

(71) Applicant: Steven Michael Aune, JR., Friendswood, TX (US)

(72) Inventor: Steven Michael Aune, JR., Friendswood, TX (US)

(21) Appl. No.: 14/110,770

(22) PCT Filed: Apr. 10, 2012
(86) PCT No.: PCT/US12/32945

§ 371 Date: Oct. 9, 2013

Related U.S. Application Data
(60) Provisional application No. 61/473,803, filed on Apr. 10, 2011.

(51) Int. Cl. H01R 13/52

(52) U.S. Cl. CPC H01R 13/5213
USPC 439/750

(57) ABSTRACT

Sleeves for protecting electrical connectors are disclosed. In various embodiments, a protective sleeve includes an elongate body configured to house a male or female electrical connector component. In various embodiments, a protective sleeve is configured with a streamlined exterior that reduces the likelihood of becoming snagged or trapped as it is being pulled from one location to another via a cable attached to the electrical connector. In various embodiments, a protective sleeve can be formed from two halves that can be disengaged from the electrical connector without requiring disconnection of the connector itself.

### CROSS REFERENCE TO RELATED APPLICATIONS

This application claims priority to and the benefit of U.S. Provisional Patent Application No. 61/473,803, filed on Apr. 10, 2011, the entire contents of which are incorporated herein by reference in their entirety.

### TECHNICAL FIELD

This disclosure relates to systems and methods for protecting cable connectors and securing connections therebetween. In particular, this disclosure relates to systems and methods for protecting camlock cable connectors.

### BACKGROUND

Heat treatment is a commonly-used industrial process for altering physical or chemical properties of a material such as a metal. The process can include heating a substance so as to achieve a desired hardness or softness which can be useful in annealing, case hardening, precipitation strengthening, tempering, and quenching, for example. Heat treating equipment can include a power control console, power cabling, and heating elements, among other equipment. The power control console can provide electrical current through the power cabling which, through resistance, heats one or more heaters, e.g., ceramic blocks. Thermocouples can be integrated into the power cabling to provide precise temperature control via the power control console in some systems.

Cable connectors allow the connection of one or more power cables, e.g., in series, and to heater and power control elements. The “camlock” (also known as “cam-lock,” “camlok,” and other variations) is a cable connector that attaches to a terminal end of a cable, and is frequently used in the heat treating industry because it provides positive locking engagement between male and female coupler components. Camlock cable connectors can be used in welding, lighting, and other industries where electrical connections are made between cables. Camlocks are typically formed of brass or another electrically-conductive material and can be applied to a terminal portion of a wire, e.g., an electrically-conductive wire used in ceramic heating applications. Some camlocks further include interlocking components that securely join male and female portions to form an electrically-conductive union therebetween. Some camlock protection devices utilize a sleeve formed of a phenolic resin to provide protection of cable connector components.

### SUMMARY

In general, this disclosure relates to protective sleeves and coverings for electrical cable connector components and related devices. In one embodiment, a protective cable connector is configured to protect the union of male and female camlock components, and is furthermore configured so that the likelihood of the cable connector becoming caught or snagged when pulled over a surface is minimized. In one example the camlock protector comprises a substantially non-conductive sleeve configured to fit snuggly over all, or a portion of a camlock, wherein the protective sleeve includes surface facets configured to allow the sleeve to ride over an obstacle (e.g., a port or tabletop at 90 degrees to the direction of travel) without disengaging from the camlock.

In one exemplary aspect, a sleeve for protecting a component of an electrical connector is provided. The sleeve includes an elongate body formed of a resilient material having an open, interior chamber at a first end, defined in part by an interior wall having a cross-sectional diameter selected to frictionally engage the outer surface of an elongate electrical coupler component when inserted into the interior chamber. The elongate electrical coupler has a complimentary diameter and cross-sectional shape about its elongate axis as the chamber, where the interior wall inwardly converges to form a constrictive aperture at a second end of the elongate body for engaging an electrically-conductive cable attached to the electrical coupler and minimizing shifting between the cable and the constrictive aperture.

In one embodiment, the exterior surface of the elongate body has a cross-sectional shape perpendicular to the elongate axis configured to engage a tool for providing mechanical leverage in rotating the sleeve in a desired direction relative to a second, substantially equivalent sleeve. In one embodiment, the cross-sectional shape is substantially circular, or has 2, 3, 4, 5, 6, 7, or 8 substantially isometric sides.

In one embodiment, the elongate body is formed from a resilient material capable of resisting thermal degradation at temperatures between about 500° F. and about 1000° F. and is also capable of resisting deformation from mechanical forces. In one embodiment, the resilient material is Nylon-6,6.

In one embodiment, the sleeve further includes one or more bores that extend through the cross-sectional diameter of the sleeve that are configured to receive a locking pin of suitable length to span the cross-sectional diameter, while passing through a bore of the electrical connector component to prevent translational and rotational shifting of the component within the sleeve. In one embodiment, when one bore of the one or more bores is aligned with the bore of the electrical connector, a first end of the electrical connector is substantially flush with the first end of the sleeve.

In one embodiment, the electrical connector is a camlock electrical connector.

In one embodiment, the sleeve further includes a male or female interlocking component for reversibly coupling a first sleeve to a second sleeve. In one embodiment, the female interlocking member comprises a cylindrical wall extending from the first end that is configured to receive a male interlocking member comprising a complementary cylindrical wall member. The cylindrical wall of the female interlocking member includes an integral tongue member that defines, in part, a channel for receiving an interlocking post disposed on the cylindrical wall of the male interlocking member.

In one exemplary aspect, a sleeve for protecting a camlock-type electrical connector is provided. The sleeve includes first and second elongate sleeve bodies. Each sleeve body includes a semi-circular channel that extends the length of the sleeve body, a locking tab on a first side of the sleeve body, a latch body on a second side of the sleeve body opposite of the locking tab, and a post member that extends perpendicularly from the semi-circular channel that is configured to be inserted into a pin bore of a camlock electrical connector body. The first and second sleeve bodies are reversibly couplable to form the sleeve by engaging the locking tab on the first sleeve body with the latch body on the second sleeve body and vice-versa, thereby creating a cylindrical bore from each of the semi-circular channels, which is configured to receive the camlock electrical body.

In one embodiment, the first and said second elongate sleeve bodies are configured substantially identically.

In one embodiment, the diameter of said cylindrical bore is complementary to the diameter of the camlock electrical connector body.

In one embodiment, shifting between the camlock electrical connector and the sleeve is minimized by orienting the camlock in the semi-circular channels of the sleeve bodies such that each of the post members is inserted into opposite sides of the pin bore of the camlock body. In one embodiment, when the sleeve is formed by engaging the first and the second sleeve bodies, the sleeve has a cross-sectional shape perpendicular to the elongate axis configured for engagement with a tool for providing mechanical leverage in rotating the sleeve relative to another of the sleeves.

In one embodiment, the exterior of the sleeve is smooth along its elongate axis so as to be capable of being pulled over an obstacle or through an aperture without abutment that would prevent further motion in the same direction.

In one embodiment, the first and second elongate sleeve bodies are formed from a resilient material capable of resisting thermal degradation at temperatures between about 500° F. and about 1000° F. and capable of resisting deformation from mechanical forces. In one embodiment, the resilient material is Nylon-6,6.

In one exemplary aspect, a system for protecting an electrical coupler component is provided. The system includes first and second reversibly-couplable elongate bodies, each of said bodies including an elongate channel configured to receive a portion of the electrical coupler, which is defined in part by an interior wall, such that when the first and second elongate bodies are coupled, the channel has a cross-sectional shape perpendicular to the elongate axis of the bodies that is complimentary to the cross-sectional shape of the electrical coupler component. The system further includes one or more recesses in the interior wall configured to receive a terminal end portion of a pin configured to extend through, and protrude from the electrical coupler component on substantially opposite sides for minimizing shifting of the coupler inside the channel when the first and the second bodies are coupled. Each of said bodies includes a complimentary half of a latch assembly configured to reversibly couple the first and second bodies.

In one embodiment, the electrical coupler component is a cylindrical male or female camlock electrical coupler component.

Certain embodiments may include one or more advantages. For example, various embodiments may exhibit substantially improved protection of electrical connector (e.g., camlock) components, including improved protection of the union between two connector components (e.g., male and female components). This advantage in particular can reduce the likelihood of injury from electrical shock and protect the overall integrity of an electrical system such as a heat treatment or welding system. Without limitation, the protective covers described herein can be advantageously used for protecting camlock-type electrical connectors in particular. For example, various implementations can exhibit substantially improved resistance to crushing forces, chemicals, and other forms of degradation as compared to phenolic-type camlock protectors. Various implementations provide increased protection of camlock components from being crushed, becoming disfigured, or otherwise damaged when using tools to assist in coupling or de-coupling male and female camlock portions. The longevity of a camlock connector and cable attached thereto can be substantially increased in various embodiments, which, correspondingly, can decrease maintenance and down time associated with repairing damaged connectors or sleeves. Various embodiments may exhibit substantially improved ability to pull camlock connectors over obstacles, e.g., a 90-degree abutment in a heat treating console, wire rack, or other structure. Various implementations may exhibit substantially increased resistance to thermal degradation. In various embodiments, the ease of disconnecting seized camlock components may be substantially improved, e.g., after becoming fused from excessive heat within the connector. In various embodiments, the thickness of a protective sleeve and its shape can be advantageously selected to provide increased leverage for connecting or disconnecting camlock components (e.g., male and female components). Various embodiments can provide a cost-saving advantage as the protective sleeves can be configured to fit male or female camlock components, or both. The exterior facet faces of some protective sleeve embodiments provide a space onto which indicia can be printed, etched, engraved, stamped, or otherwise provided. This provides an advantage of easily and safely recognizing the protective sleeve itself, and any associated parameters of the electrical connector therein, e.g., the purpose of the connector (or, more specifically, the electrical cabling), any associated dangers (e.g., high-voltage), the rating of the connector, or any other information the user may deem pertinent.

Unless otherwise defined, all technical and scientific terms used herein have the same meaning as commonly understood by one of ordinary skill in the art. The term “cable” as used herein is synonymous with “wire,” “cord,” and other similar terms referring to materials configured to conduct electricity. Although methods and materials similar or equivalent to those described herein can be used in the practice or testing of any described embodiment, suitable methods and materials are described below. In addition, the materials, methods, and examples are illustrative only and not intended to be limiting. For example, many of the illustrative embodiments in this disclosure relate to protective coverings for camlock cable connectors. It will be understood, however, that the various embodiments can be used for protecting other types of electrical connectors. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### DESCRIPTION OF DRAWINGS

The present embodiments are illustrated by way of the figures of the accompanying drawings in which like references indicate similar elements, and in which:

FIG. 1A is a perspective view of a protective sleeve according to one embodiment;

FIG. 1B is a side view of the protective sleeve shown in FIG. 1A according to one embodiment;

FIG. 1C is a perspective view of the protective sleeve shown in FIG. 1A according to one embodiment;

FIG. 1D is a sectional view of the protective sleeve shown in FIG. 1A according to one embodiment;

FIG. 1E is an end view of the protective sleeve shown in FIG. 1A according to one embodiment;

FIG. 1F is a side view of the protective sleeve shown in FIG. 1A according to one embodiment;

FIG. 2 shows two protective sleeves in a coupled orientation according to one embodiment;

FIG. 3 is a protective sleeve according to one embodiment;

FIGS. 4A, 4B, and 4C show right perspective, left perspective, and axial views respectively of a protective sleeve according to one embodiment;

FIG. 5 shows one embodiment of a protective sleeve;

FIGS. 6A-6H show various views of a protective sleeve according to one embodiment;

FIGS. 6I-6L show various views of a protective sleeve according to one embodiment; and

FIGS. 7A-7D show various views of a protective sleeve according to one embodiment.

### DETAILED DESCRIPTION OF ILLUSTRATIVE EMBODIMENTS

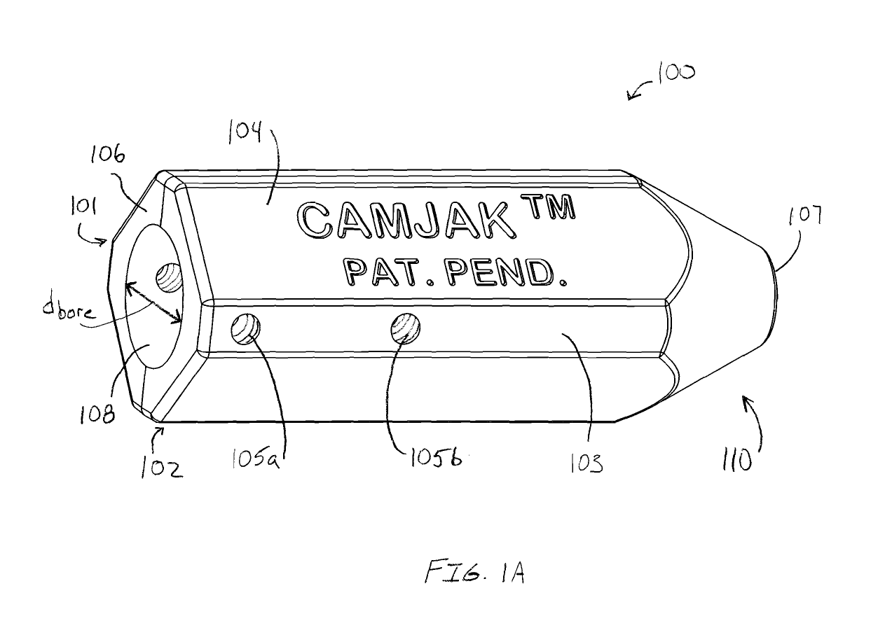

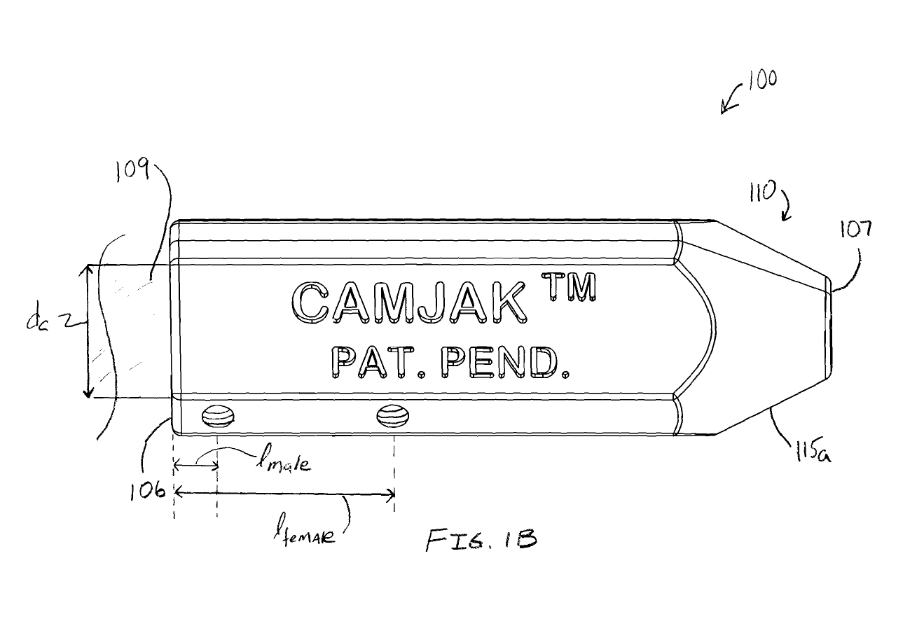

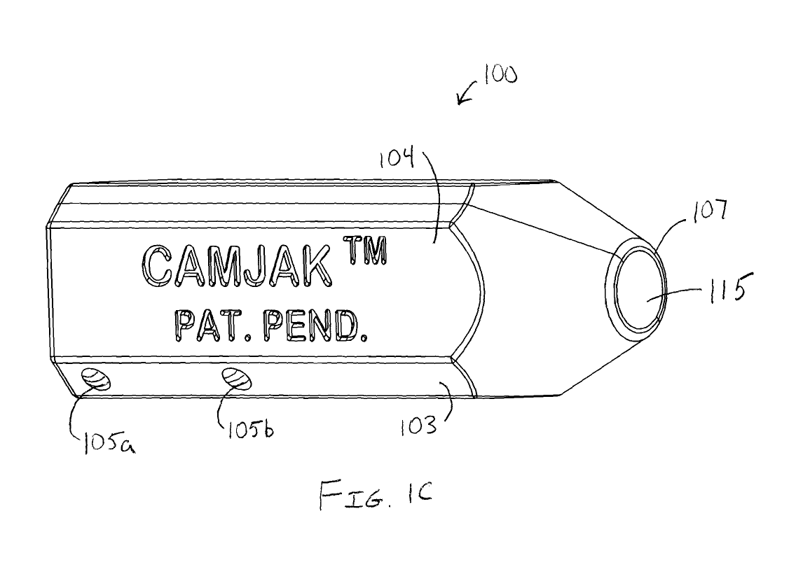

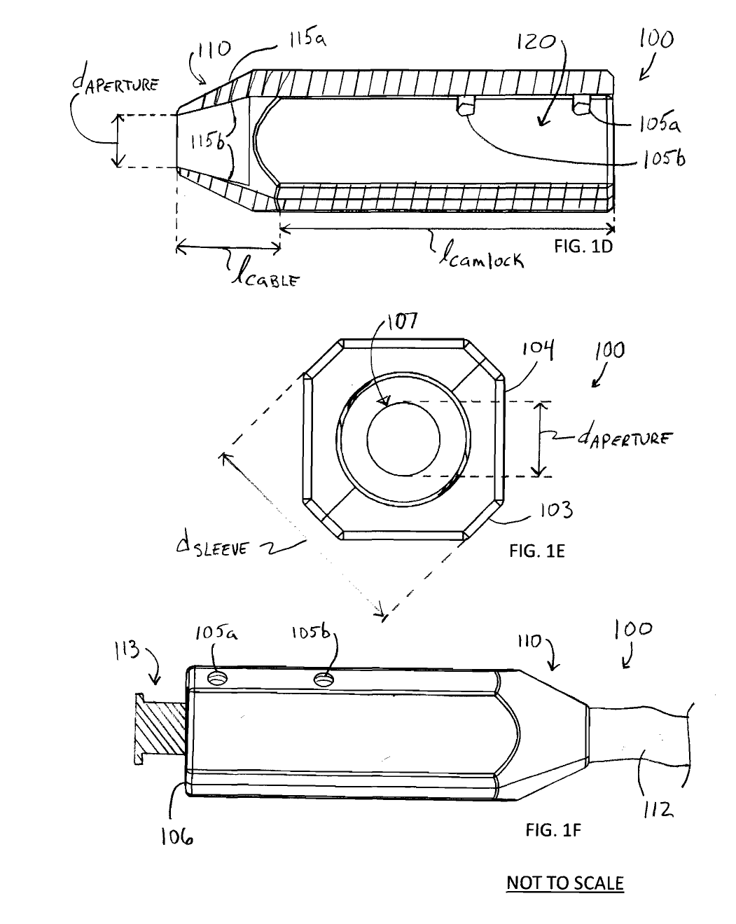

FIGS. 1A-1F show various views of an elongate protective sleeve (hereinafter “sleeve”) 100 according to one exemplary embodiment. The sleeve 100 can be configured to house and protect a male or female portion of an electrical cable connector, and in particular, a male or female component of a camlock electrical cable connector. The sleeve 100 can be configured to allow access to the interlocking members of male and female camlock components so that an electrical connection therebetween can be made. In various embodiments, making an electrical connection between male and female camlock components can bring two sleeves 100 (one on each of the male and female camlock components) into a confronting relationship, thereby providing protection of the camlock components and interlocking members thereof, as explained in greater detail herein.

In this embodiment, the sleeve 100 is formed from left (101) and right (102) body halves of a resilient material such as plastic, which can provide simplicity in production of the product, e.g., using techniques such as plastic injection molding. It will be understood, however that a sleeve 100 can be formed as a single, integral piece in this and other embodiments. In various implementations, a factor in choosing between forming a sleeve 100 as a halved pieces or in one solid piece can be the amperage rating of the camlock the sleeve is designed to house. For example, in one embodiment, a two-piece sleeve can be designed for housing a camlock rated for 60 amps; in another embodiment, a one-piece sleeve can be designed for housing a camlock rated for 300 amps.

In this embodiment, the sleeve 100 includes a cylindrical bore generally defined by a tubular interior wall 108 for receiving all or a portion of a male or female camlock component. While this and other embodiments described herein include a cylindrically-shaped bore for receiving a camlock, it will be understood that in any of the described embodiments, the bore can be alternatively configured to accommodate other camlock shapes, e.g., square, hexagonal, octagonal, etc. In this and other embodiments, a sleeve 100 can be configured to allow female camlock components to be substantially fully housed by the sleeve 100, where the receptacle of the female interlocking member is generally flush with an end face 106 of the sleeve 100. In this and other embodiments, face 106 can be substantially planar so that faces 106 of two sleeves 100 can be brought into a confronting relationship with minimal void space therebetween when two camlock components are interlocked in an operational (e.g., electricity-conducting) configuration. In this and other embodiments, a sleeve 100 can be configured to allow a male camlock component to be substantially housed within the sleeve 100, except that the male interlocking member 113 of the camlock component can extend beyond the end face 106 for coupling to a female camlock component. (See, e.g., FIG. 1F.) Referring specifically to FIG. 1D, a sleeve 100 can include an interior camlock chamber 120 having a length l_{camlock} as shown. In general, the length l_{camlock} of the camlock chamber 120 can be configured to house male or female camlock components as previously described; e.g., a sleeve 100 configured to house a male camlock component can have a housing chamber where l_{camlock}=1 7/16 inches, and a different sleeve 100 can be configured to house a female camlock component can have a housing chamber where l_{camlock}=2.5 inches.

In this embodiment, the diameter of the sleeve bore d_{bore} can be equal, or nearly equal to the diameter d_{c} of a cylindrical camlock so as to provide frictional engagement with minimal shifting when the camlock is inserted into the sleeve 100. For example, a sleeve 100 can have a camlock chamber 120 having a diameter d_{bore} of about 0.950 inches, about 0.5 inches, etc. In this and other embodiments, the diameter d_{bore} can be selected to receive a camlock or other type of electrical connector of any size or shape.

In this embodiment, the sleeve 100 includes pin bores defined by cylindrically-shaped interior walls 105a, 105b that bisect the camlock chamber 120. The pin bores 105a, 105b can be configured to receive and hold, through frictional or other forces, a locking pin that extends through the sleeve 100 and a bore within the camlock 109 to lock the camlock 109 and sleeve in relative positional engagement. The length of the locking pin (not shown in FIGS. 1A-E for clarity) can be equal to the diameter of the sleeve dₛₗₑₑᵥₑ as referenced in FIG. 1E. It will be understood that a sleeve 100 can include as many pin bores as necessary to provide locking engagement between a camlock and the sleeve. In some embodiments, the locations of the pin bores can be selected so that the sleeve 100 can accommodate either a male or a female camlock component, where the pin bore of the camlock will align with at least one pin bore of the sleeve 100 when the camlock component is inserted therein. For example, referring specifically to FIG. 1B, a first pin bore can be positioned a length lₘₐₗₑ away from the end face 106 to accommodate the position of the pin bore in a male camlock component; likewise, a second pin bore can be positioned a length l_{female} from the end face 106 to accommodate the pin bore position of a female camlock component when inserted into the sleeve 100. Thus, one sleeve 100 can be used for securing either male or female camlock components, which can be advantageous both in manufacturing cost and time savings when performing field repairs on electrical connectors.

In this embodiment, the exterior surface of the sleeve 100 includes a plurality of facets, e.g., facets 103 and 104. As best realized in FIG. 1E, the thickness of the sleeve tₛₗₑₑᵥₑ is greatest between the inner wall 108 and the narrower facet 103 (as compared to facet 104). Thus, in a preferred embodiment, the location of the pin bores can be selected on a narrow facet, e.g., facet 103, where the greater sleeve thickness can provide maximum structural integrity and reduce the likelihood of sleeve breakage if shear occurs between the camlock and the sleeve 100.

Referring to FIGS. 1D, 1E, and 1F in particular, in this embodiment, the sleeve 100 includes a tapered end portion 110 defined by an inwardly converging wall 115a on the exterior of the sleeve, and an inwardly converging wall 115b within the interior of the sleeve 100. The tapered end portion 110 converges to an open distal end 107 having an aperture that is configured to receive an electrical cable 112 (see, e.g., FIG. 1F) that can be connected to a camlock. In this and other embodiments, the diameter of the aperture dₐₚₑᵣₜᵤᵣₑ can be chosen so as to provide positive engagement with the cable 112 and minimal shifting therebetween. FIG. 1F shows a male interlocking member 113 of an interiorly-housed camlock extending from end face 106 on the left side of the sleeve 100. In a preferred embodiment, the inwardly-converging walls 115a, 115b converge at the distal end 107 at a minimum angle so as to minimize the thickness of the sleeve at the distal end. This configuration provides an advantageously smooth transition between the exterior surface of the cable 112 and the exterior surface of the sleeve 100, so that the cable and the sleeve can be freely pulled over obstacles and through apertures.

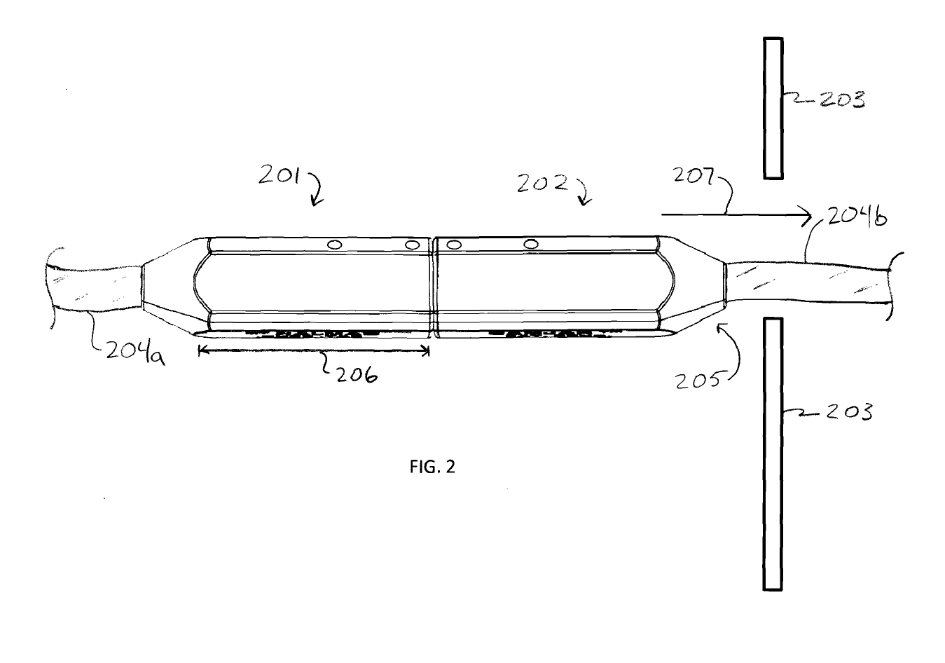

As is known particularly in the heat treating and welding industries, male and female camlock components can be difficult to separate if they have been damaged as a result of heating or overheating, physical damage (e.g., disfiguration), or chemical processes such as corrosion. In this exemplary embodiment, the sleeve 100 includes a plurality of facets (e.g., facets 103, 104) so that the sleeve 100 can be engaged by a hand tool such as a box wrench or crescent wrench to assist in disengaging male and female camlock components housed within the sleeve 100. In one example, the cross-section of the sleeve 100 has a substantially square, hexagonal, or octagonal shape to allow gripping by hand or a variety of hand tools. In one example, a user can break a connection between male and female camlock components (wherein each component is housed within a separate sleeve 100; see, e.g., FIG. 2) by engaging a hand tool on each sleeve and applying torque to the sleeves in opposite directions, as will be apparent to those skilled in the arts.

In this and other embodiments, a sleeve 100 can be formed from hard, resilient polymers, plastic, rubber, or other material capable of withstanding temperatures between about 500° F. and about 1000° F. without degrading, and also capable of resisting physical degradation from mechanical stress, compression, etc. In a preferred embodiment, the sleeve 100 is formed from a nylon resin having a high resistance to thermal degradation such as Nylon-6,6, however, other materials can be used. Other exemplary nylon resins are sold under the Zytel brand by E.I. du Pont de Nemours and Company. In addition to resistance to thermal degradation, it can be preferable to use a material having high resistance to physical, chemical, and environmental damage, and electrical resistivity.

Referring now to FIG. 2, male and female components of a camlock connecter are coupled in electrically-conductive engagement, where two sleeves 201, 202 separately house the male and female components, respectively. In this embodiment, the sleeves 201, 202 can be similar to any sleeve embodiment described herein. (The camlock components are not shown in FIG. 2 for clarity.) Electrical wire 204a, 204b, which is coupled to the male and female components respectively, extends from the terminal end of each sleeve 201, 202.

In one exemplary aspect, the tapered ends of the protective sleeves described herein allow camlock connectors housed therein to be pulled through apertures and over obstacles without snagging. FIG. 2 illustrates the pair of sleeves 201, 202 moving from left to right as indicated by arrow 207, toward a plate 203 having an aperture through which the wire 204b extends. As described above, the tapered portion 205 provides a gradual slope from the main body 206 of the sleeve to the surface of the wire 204. Thus, as the pair of sleeves 201, 202 approaches the plate 203, the tapered portion 205 of sleeve 202 will encounter the aperture and urge the sleeve 202 in a direction that allows the sleeve to pass through without snagging. As is evident from the illustration of FIG. 2, the pair of sleeves 201, 202 can be pulled from either direction through the plate 203 and the tapered portion of either sleeve 201 or sleeve 202 will reduce the likelihood of snagging as previously described.

In certain exemplary embodiments, the exterior surface of the sleeve (e.g., sleeve 201) is smooth along the long axis, e.g., it is free from protrusions, bumps, ridges, walls, notches, or other structural features that extend perpendicular to the exterior sleeve surface. This configuration can further reduce the likelihood of a portion of the sleeve becoming snagged or lodged against a surface when it is being moved from a first position to a second position, e.g., when it is being pulled through an electrical console or wall. In an exemplary use of two or more sleeves, it can be advantageous to align the facets of each sleeve to produce a substantially contiguous facet spanning both sleeves, as is depicted in FIG. 2.

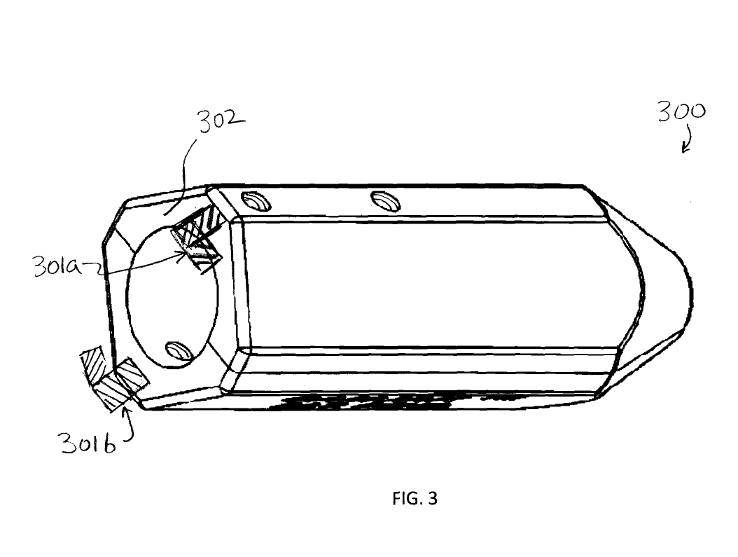

In one exemplary aspect, protective sleeves of the type described herein can include features that allow sleeves to be reversibly-interlocked to reduce the likelihood of accidental or unintended camlock (or sleeve) separation. Referring now to FIG. 3, a camlock sleeve 300 having a male interlocking component is shown. In this embodiment, the sleeve 300 includes two locking posts 301a, 301b protruding from end surface 302. The locking posts 301a,b can engage a female camlock sleeve (not shown) having a pair of slots configured to receive the locking posts 301a,b on a corresponding end surface (i.e., surface 302 of the female sleeve). In one exemplary aspect, a male camlock sleeve can be releasably engaged with a female camlock sleeve by inserting the locking posts 301a,b into the slots of the female sleeve and twisting the male camlock sleeve to reversibly lock the sleeves together in an orientation similar to that shown in FIG. 2. In a preferred embodiment, the position of the posts 301a,b and/or the female receptacle slots on the flat surface 302 of the sleeve are such that rotating the sleeves into locking engagement concurrently aligns the facets of each sleeve to arrive at the preferred orientation as shown in FIG. 2. It will be understood that other mechanisms can be used to releasably engage male and female sleeves, including, but not limited to threaded portions that allow sleeves to be screwed together, post/camlock combinations, clips, locks, and other mechanisms that will be apparent to those skilled in the arts.

Referring back to FIG. 1A, those familiar with electrical connectors will appreciate that some camlocks require the male and female components to be rotated in opposite directions after the male portion has been inserted into the female portion to lockingly engage the pair, e.g., rotation by a quarter-turn, half-turn, etc. The rotation of one camlock component relative to the other can follow a groove or thread that brings the camlock components into a substantially confronting relationship. Accordingly, in preferred embodiments, the location of the pin bores 105 can be selected so that when male and female camlock components are lockingly engaged, the exterior facets of the sleeves are aligned to match with one another, as shown in FIG. 2. Thus, in some embodiments, particularly those where a camlock connector requires a 45-degree turn to lockingly engage male and female components, the pin bores (e.g., 105a, 105b) can be positioned on a wide facet (e.g., facet 104) while the pin bores on the corresponding opposite sleeve has pin bores positioned on a narrow facet (e.g., facet 103). It will be apparent to those skilled in the art that other pin bore locations can be selected; including providing male/female sleeve pairs where the location of the pin bores on each component are selected to provide optimal facet matching when camlock components are lockingly engaged.

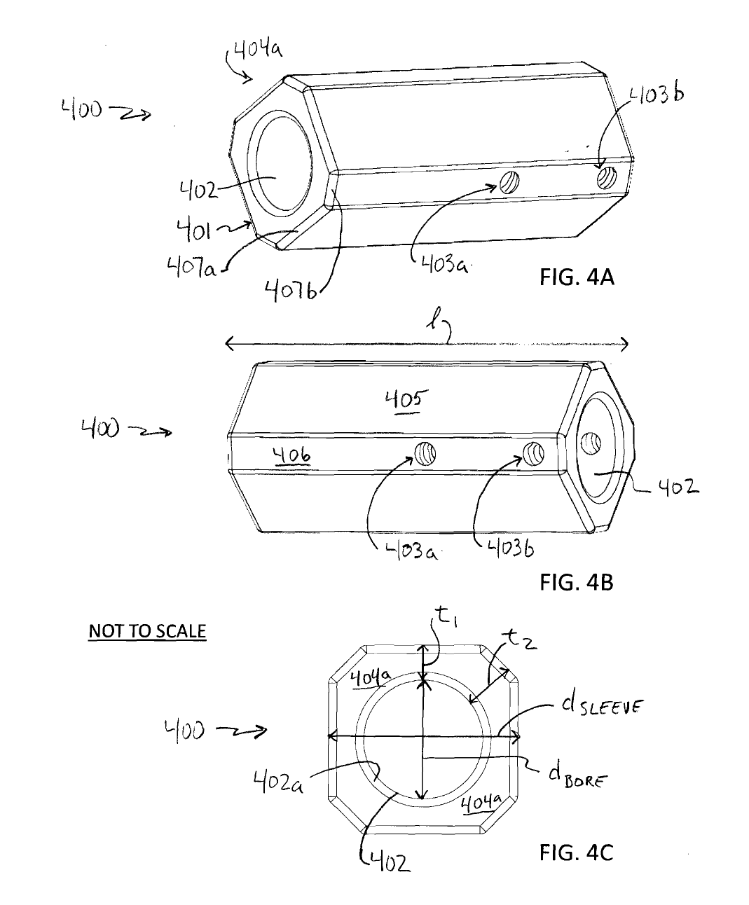

Referring now to FIGS. 4A, 4B, and 4C, a protective sleeve 400 is shown, according to one embodiment. Similar to other embodiments described herein, the sleeve 400 includes a body 401 having a central bore defined by a cylindrically-shaped interior wall 402 for receiving an electrical connector such as a camlock (not shown in FIG. 4A or 4B for clarity of the figures). In preferred embodiments, the diameter d_{bore} of the bore is substantially equal to the diameter of the electrical connector so as to provide a complementary fit as described above. The length of the sleeve (denoted l in FIG. 4B) can be chosen so as to provide complete enclosure of the electrical connector within the bore. The sleeve 400 can include one or more pin bores 403a-b for receiving a locking pin (not shown in FIG. 4A) that extends through the body 401 orthogonal to the long axis, as illustrated. The pin bores 403a-b can be configured and sized for receiving pins that extend through an electrical connector disposed within the bore 402 and lock the relative positions therebetween.

Referring specifically to FIG. 4C, in this embodiment, the sleeve 400 has a substantially square shape when viewed down the long axis (i.e., looking down the axis of the bore as shown in FIG. 4A), which is formed from a series of circumferential facets, e.g., facets 405, 406. The facets on this and other sleeve embodiments can be used for gripping purposes. For example, the facets can provide a gripping surface for hand manipulation of the sleeve 400; similarly, the facets can provide surfaces configured to be gripped by a tool, such as a box wrench or channel locks. In other embodiments, the sleeve can be configured in alternate shapes, including square, hexagonal, octagonal, etc. In this embodiment, the terminal ends 404a, 404b of the sleeve are rounded where the facets (e.g., facets 405, 406) meet the terminal faces 404a, 404b of the body 401; exemplary rounded edges are indicated at 407a and 407b in FIG. 4.

In this embodiment, the sleeve body 401 can have a desired thicknesses. For example, the body 401 can have a desired thickness t₁ as measured from the outer circumference of the bore (denoted as 402a) to a major facet 407a on the outermost surface of the body 401; likewise, the body 401 can have a desired thickness as measured from the outer circumference of the bore (402a) to a minor facet 407b on the outermost surface of the body 401. Similarly, the diameter of the sleeve dₛₗₑₑᵥₑ, which is the distance between opposite facets of the sleeve 400, can be chosen to accommodate standard tool sizes, for example, a ⅜-inch wrench, a ¾-inch wrench, etc. The diameter of the sleeve can similarly be chosen to accommodate a desired tool or tool size in embodiments where the shape of the body 401 is hexagonal, octagonal, etc. (as viewed from the perspective of FIG. 4C).

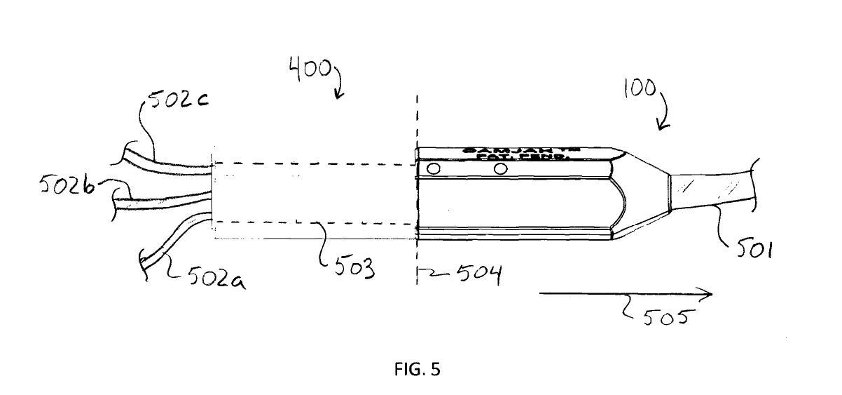

Unlike other sleeve embodiments described herein, the terminal ends 404a, 404b respectively of the sleeve body 401 are substantially flat. Referring now to FIG. 5, in one preferred use of the sleeve embodiment shown in FIGS. 4A-4C, a first sleeve 400 can be used for protecting electrical connectors that connect to, or join, a plurality of electrical cable; such electrical connectors are commonly referred to as “splitters” by those skilled in the art. In the preferred use, the sleeve 400 can accommodate an electrical connector, e.g., a male camlock component 503 (shown as a dashed line to indicate that it is inside of the sleeve 400) that connects to a plurality of electrical cables (e.g., cables 502a-c). The male camlock component 503 can connect to a female camlock component (not shown in FIG. 5) disposed within a second sleeve 100 (sleeve 100 is the same as that described with respect to FIG. 1). The male-to-female camlock connection can be located generally at the plane (denoted 504) where a first face 404a on the first sleeve 400 is brought to a confronting relationship with a second face 106 on the second sleeve 100. A single cable 501 is shown protruding from the sleeve 100 to illustrate that a single cable is connected to the female camlock component.

As those skilled in the heat treating industry will recognize, often times electrical cable is gathered for re-use by “pulling” the cable back to a central location. It is often the case that the direction of the cable pull is away from the splitter, e.g., in the direction of the arrow 505 shown in FIG. 5. Thus, sleeve 400 does not necessarily require a tapered end for reducing the likelihood of snagging on objects as the cable is pulled. It will be understood, however, that sleeve 400 can indeed include a tapered end portion similar to sleeve 100, previously described, which itself can accommodate a plurality of electrical cables, e.g., cables 502a-c as shown in FIG. 5.

In one embodiment, protective sleeves e.g., sleeves 100 and 400 can be formed of a material such as a plastic or other polymer material that is capable of resisting thermal degradation from the heat of an electrical connector disposed therein, as well as from contact with hot items such as heating pads used in the heat treatment industry. In one embodiment, the protective sleeve is configured to safely carry up to about 300 amps of electrical current.

Similar to other embodiments described herein, sleeves, such as sleeve 400 can include indicia to aid the user in identifying the cabling (e.g., cables 502a-c) or other information. Written indicia can be applied to any sleeve embodiment by, for example, laser etching. A sleeve 400 can be colored to indicate useful information to a user, such as identifying one or more heating pads that connect to the electrical connector within the sleeve.

In some embodiments, sleeves of the type described herein can be colored to provide visual identification of the camlock housed within. For example, in an exemplary heat-treating aspect, camlock sleeves of one color can be used to identify heating wires leading to a particular location, or identify heating wires of a particular electrical parameter such as the amount of current the sleeve is designed to handle safely.

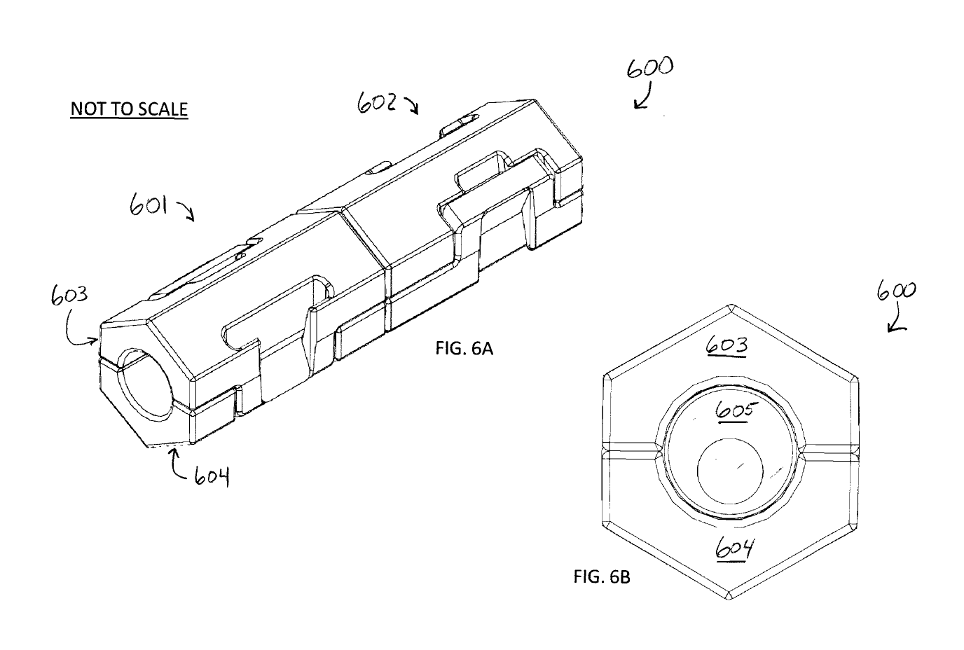

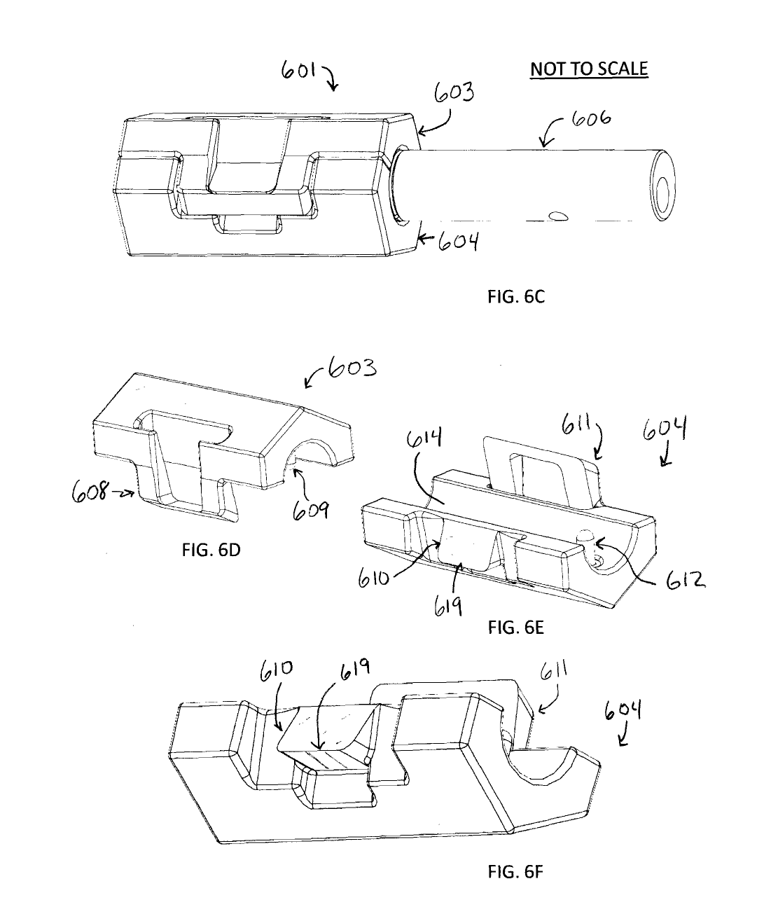

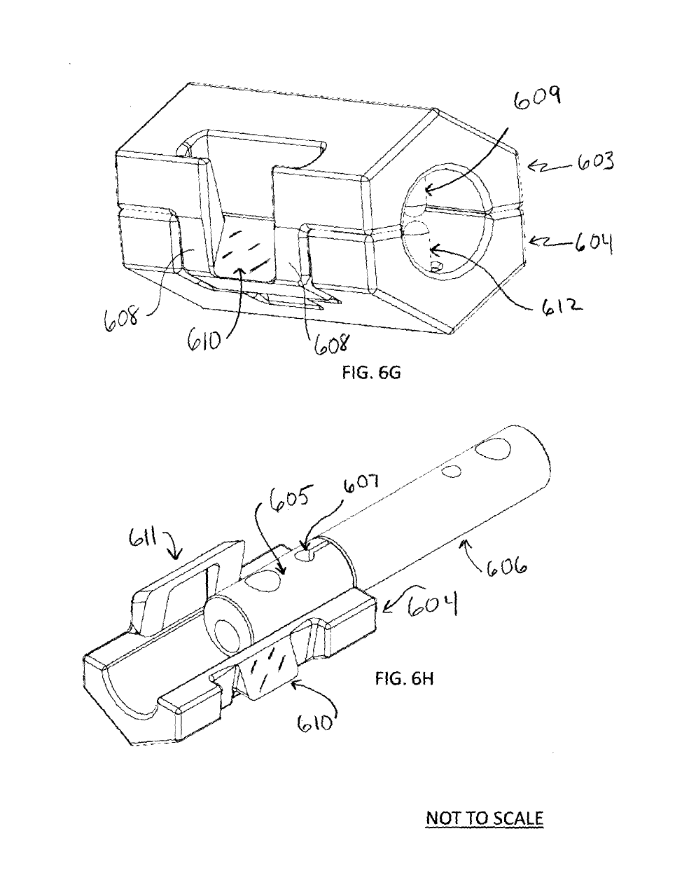

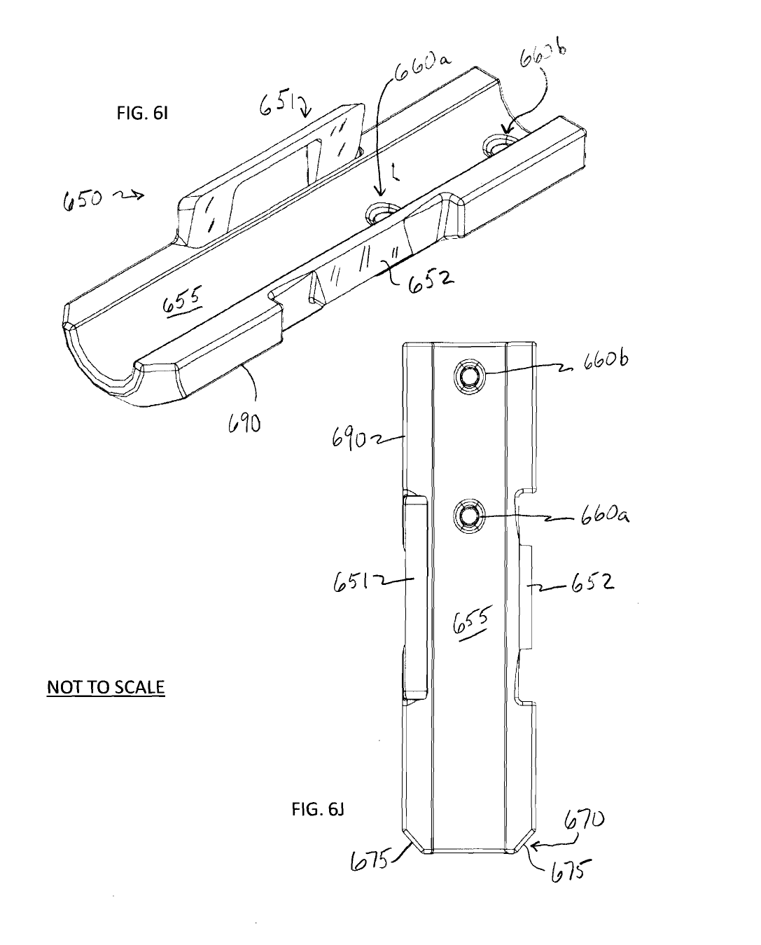

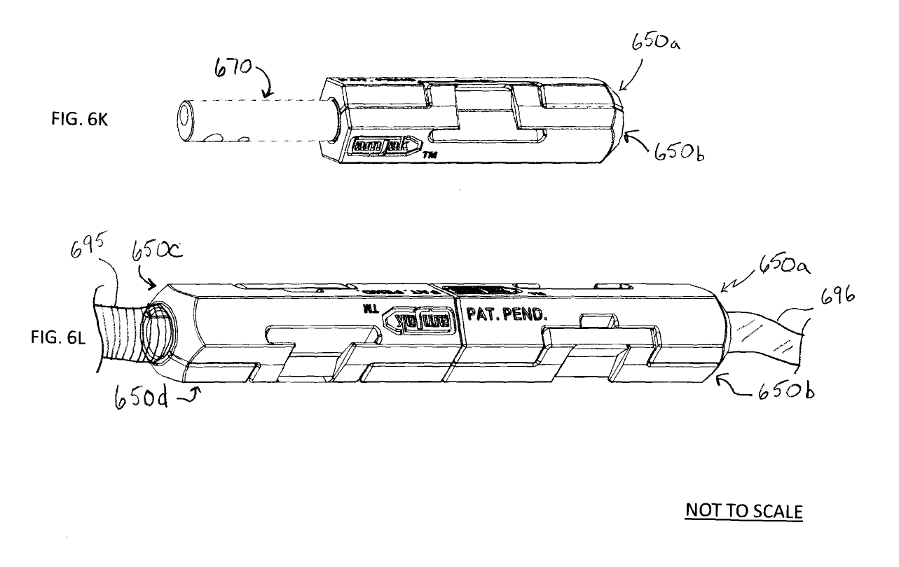

Referring now to FIGS. 6A-6H, various views of a protective sleeve 600 for an electrical connector is shown. In this embodiment, the sleeve 600 is formed of a male 601 and female 602 sleeve component that cover male and female components of an electrical connector, respectively. In describing this exemplary sleeve embodiment, the electrical connector is a camlock connector 605, however, it will be understood that other electrical connectors and equivalents can be substituted.

The sleeve components 601, 602 include a top body 603 and a bottom body 604. Hereinafter, various components of the sleeve 600 are illustrated and discussed for the male sleeve component 601 only, for clarity; however, it will be understood that the female sleeve component 602 can be formed of the same elements and can be similarly constructed.

The top and bottom bodies 603, 604 can be releasably fastened together using an interlocking mechanism. In this embodiment, the interlocking mechanism is a snap having locking components on top 603 and bottom bodies 604; however, other locking mechanisms can be used. The top body 603 includes a first semi-flexible latch arm 608 that is configured to engage a first latch body 610 on the bottom body 604. Similarly, the bottom body 604 includes a second semi-flexible latch arm 611 that is configured to engage a second latch body (not shown in FIGS. 6A-6H) on the top body 603. The interlocking mechanism can be configured to releasably couple top 603 and bottom 604 bodies by aligning the latch arms to their respective latch bodies and pressing the two bodies 603, 604 together until they are in latched engagement, as shown in FIG. 6F. In this embodiment, the latch bodies (e.g., 610) are sloped, which urges the latch arm (e.g., 608) to resiliently splay outward when the bodies 603, 604 are pushed together until the peak of the body (e.g., 619) is reached, at which point the latch arm can snap inwardly to substantially surround the base of the latch body (e.g., 610). To decouple the bodies 603, 604, a user can grasp portions of the latch arms 608, 611 and flex them outwardly so as to clear the height of the latch bodies (e.g., 610), then pull the top and bottom bodies 603, 604 apart.

In this and other embodiments, the interlocking mechanism can be a latch arm and a latch body, a buckle, a snap, or any other interlocking mechanism.

In this embodiment, each of the top 603 and bottom 604 bodies includes a post 609, 612 respectively that is configured for insertion into a camlock bore 607. Other embodiments described herein can similarly include one or more post as hereafter described. The posts 609, 612 reduce or eliminate shifting of the camlock 605 relative to the sleeve component 601, and in particular, relative to the top and bottom bodies 603, 604. An integral post can also reduce the time it takes to attach a sleeve to an electrical connector, since the post can reduce or eliminate the need for a locking pin as previously described. It will be understood that other mechanisms can be employed to reduce or eliminate shifting of the camlock, including, but not limited to: the use of pins and pin bores, as described herein, friction and pressure couplings, etc.

In one embodiment, the top 603 and bottom 604 bodies are joined by a hinge member (not shown in FIGS. 6A-6H) along the long axis of the bodies that allow the bodies to open and close in a clamshell-like fashion. In this embodiment, the bodies can be interlocked as described above, with the use of a latching mechanism on one side.

The protective sleeve 600 shown in FIGS. 6A-6H includes a substantially flat surface on each terminal end of the sleeve, making it particularly useful for protecting splitter connections as described above. It will be understood, however, that either or both the sleeve components 601, 602 can include tapered ends similar to that described with respect to FIGS. 1A-1F which reduce the inner diameter of the bore to that of the diameter of one or more wires connected to the camlock.

Referring now to FIGS. 6I-6L, one half of a protective sleeve 650 is shown according to one embodiment. Here, the sleeve the sleeve half 650 includes an elongate body 690 formed of a resilient, heat-resistant material such as heat-resistant plastic or resin. The body 690 includes a semi-circular channel defined by an interior semi-circular wall 655 that extends the length of the elongate body 690. The wall 655 includes first (660a) and second (660b) circular dimples configured for receiving a terminal end of a pin that can extend through, and slightly protrudes from opposite sides of a male or female camlock component. The slightly protruding portions of the pin from the camlock component can fit into one of the dimples 660a or 660b to prevent the camlock from shifting along or in the semicircular wall 655. The body 690 further includes a latch arm 651 that is configured to snap around a latch body 652 on a different, but substantially equivalent sleeve body 690. The body 690 further includes a tapered end portion 670 defined by an inwardly-converging wall 675.

Referring specifically to FIGS. 6K and 6L, in this embodiment, a protective sleeve can be formed by joining two sleeve bodies 650a and 650b via the latch mechanism, e.g., by snapping the latch arm 651 of a first sleeve 650 around the latch body 652 of a second sleeve 650 as illustrated. Sleeve bodies 650a and 650b can be substantially identical, where the symmetry of the body 690 allows the sleeve halves 650a, 650b to be assembled into a sleeve capable of housing a camlock for protective purposes as described herein. During assembly, the sleeve halves 650a, 650b can be oriented to ensure that the dimples on each half receive the terminal portion of the locking pin that spans and slightly protrudes from the camlock as previously described. FIG. 6K illustrates an assembled, protective camlock sleeve formed of two sleeve halves 650a, and 650b. In this illustration, the sleeve is housing a male component of a camlock connector, which is shown coupled to an un-housed female camlock connector component 670. FIG. 6L illustrates an operational configuration of a protective sleeve for a camlock connector assembled from four sleeve halves, 650a-d. In this illustration, both male and female camlock components are housed within the protective sleeve; a cable 695 connected to the female camlock component 670 is shown extending from the tapered end 675 of one side of the sleeve, and a separate cable 696 is shown extending from the tapered end 675 on the other side of the sleeve, which is coupled to the male camlock component (not shown). As with any other embodiments described herein, the sleeve (e.g., the sleeve halves 650) can be made of heat-resistant materials that resist degradation at the working temperature of the electrical connector. Similarly, the sleeve can be formed from materials that resist degradation from mechanical stress, chemical exposure, or other occupational hazards. As with any other embodiment, the sleeve can be sized to accommodate camlocks of any size, configuration, or shape, and the thickness of the sleeve can be adjusted to safely protect users based, in part, on the amperage or voltage the camlock is designed to carry.

In this and other embodiments, the protective sleeves, e.g., sleeves 600, 650 can be formed of a material such as a plastic or other polymer material that is capable of resisting thermal degradation from the heat of an electrical connector disposed therein, as well as from contact with hot items such as heating pads used in the heat treatment industry. In one embodiment, the protective sleeve is configured to safely insulate a camlock connector rated for about 60 amps of electrical current; in another embodiment, the protective sleeve is configured to safely insulate a camlock connector rated for about 300 amps of electrical current.

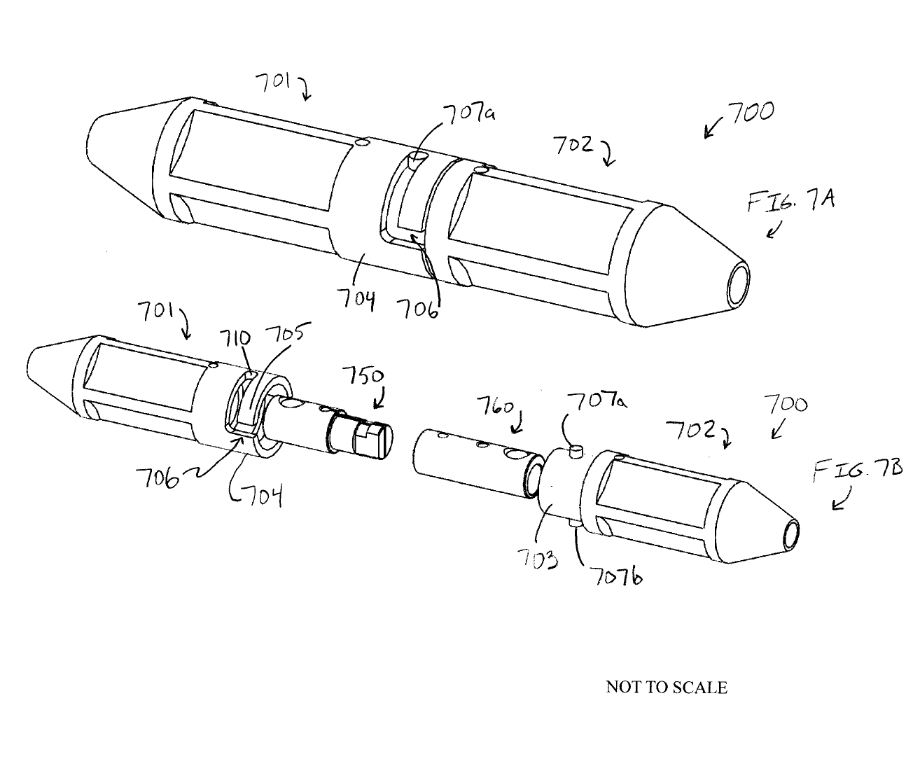

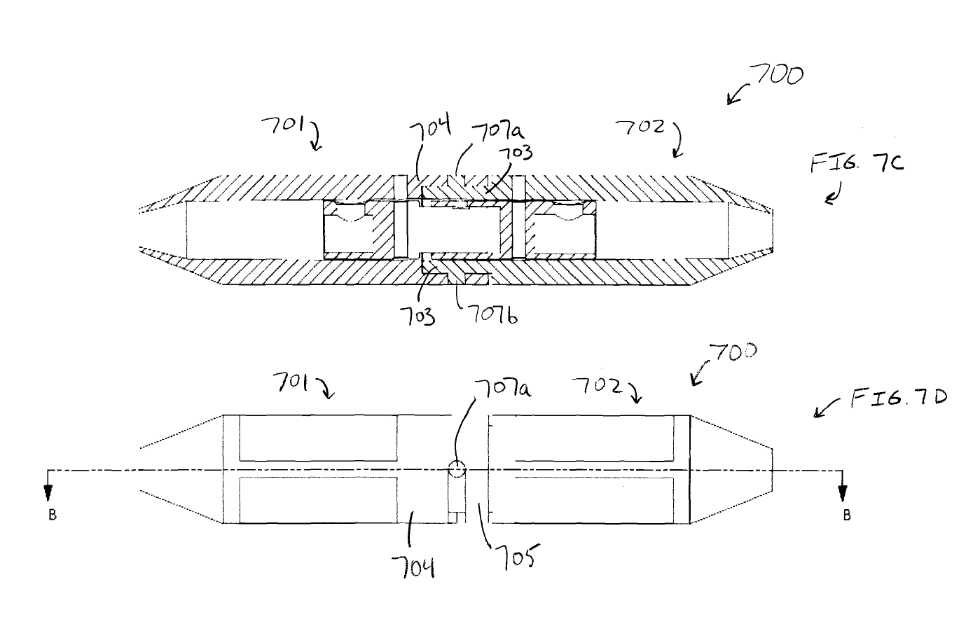

Referring now to FIGS. 7A-7D, a protective sleeve 700 is shown according to one embodiment. FIG. 7A shows the sleeve 700 in an assembled and operative configuration (cables from the interiorly-housed camlocks are not shown in FIGS. 7A-7D for clarity); FIG. 7B shows the sleeve 700 and the camlock connector in an exploded view; FIG. 7C shows a cross-sectional view of the sleeve 700 along the B-B line denoted in FIG. 7D. The sleeve 700 includes first (701) and second (702) sleeve halves configured to house male (750) and female (760) components respectively of a camlock connector, e.g., as described herein. In this embodiment, the sleeve 700 includes structural components for both shielding the union of the camlock male and female components, and also interlocking the first (701) and second (702) sleeve halves.

In this exemplary embodiment, the first half (701) of the sleeve includes a protruding circular wall 704 that originates from an end of the sleeve half as best illustrated in FIG. 7B. The circular wall 704 defines a bore configured to receive a corresponding circular protuberance 703 extending from an end of the second sleeve half (702) as shown. A tongue member 705 on the first half 701 provides a channel 706 in the circular wall 704 for receiving a locking post 707a disposed on the protuberance 703 of the second half 702. (In this embodiment, the second sleeve half 702 includes two locking posts, 707a, 707b; locking post 707b can fit into a locking channel similar to channel 706 (disposed on an opposite side of the circular wall 704), but which is not shown in FIGS. 7A-7D.) The first (701) and second (702) halves of the sleeve can be assembled as shown in FIG. 7A by lining up the locking posts 707a, 707b with the channels of the circular wall 704, inserting the circular protuberance 703 into the bore defined by the circular wall 704, and twisting one of the halves (701 or 702) such that the locking posts 707a, 707b abut a terminal end of the channel (e.g., 710). In this embodiment, the circular wall 704 can protect the interiorly-housed camlock where the connection between male and female components is made from moisture, debris, and other materials.

In general, any of protective sleeves of the type described herein, and their equivalents can have alternative configurations, arrangements, and structural components to provide certain advantages. In one example, any portion or all of a sleeve body can be formed of a honeycomb mesh (while retaining the general shape of the various embodiments illustrated herein) to provide air flow to the electrical connector for cooling purposes. In such an embodiment, the honeycomb mesh can be made from a heat-resistant plastic or other polymer, and the honeycomb structure can allow air to flow directly to portions of the electrical connector surface. In a similar example, a sleeve of the type described herein can include heat-radiative fins, slots or channels to provide air flow to the surface of the electrical connector, and other structures for reducing the temperature of the electrical connector.

In general, sleeves of the type described herein can increase worker safety as compared to traditional forms of electrical connector protection. For example, the sleeves can be made from material(s) that resist cracking, breaking, crushing, disintegration, or other structural failure, thus reducing the likelihood that a worker can be shocked from accidentally coming into contact with an exposed portion of an electrical connector such as a camlock. Furthermore, because protective sleeves of the type described herein can include structural components to prevent shifting of the electrical connector relative to the sleeve, the likelihood of a conductive portion of the electrical connector being exposed to a worker is reduced. Furthermore still, because male and female portions of protective sleeves as described herein can be positively engaged into a locked relationship, the likelihood of the sleeve becoming disengaged and thereby exposing the electrical connector is reduced.

In general, protective sleeves of the type described herein can be colored, or include written indicia to allow the user to easily identify an electrical connector within the sleeve, its type (e.g., splitter), or any other useful information. In particular, written or other indicia can be particularly advantageous in the heat treatment industry, where it can be beneficial to keep track and account for tens or hundreds of electrical connectors that may be deployed in a particular heat-treating configuration.

In general, the tapered ends of the protective sleeves described herein allow the sleeves, and electrical connectors disposed therein, to be pulled over and around objects, and through ports or other apertures without snagging. This can lead to reduced damage to the protective sleeve, the electrical connector, and associated cables, and furthermore reduce the risk of electric shock to users by protecting the aforesaid components.

In general, sleeves of the type described herein can provide certain benefits for coupling and decoupling electrical connectors. In general, the sleeves can be formed of rigid materials, e.g., plastics, and the bores that receive the electrical connector can be molded into a preferred shape. Thus, for electrical connectors having, e.g., a square or hexagonal cross-section (i.e., a cross-section parallel to the plane of rotation used for coupling and decoupling an electrical connector) the bore can have a complimentary shape, and the outermost surface of the sleeve can similarly be formed having facets that allow positive gripping by hand or using tools.

In a related advantage, male and female components of electrical connectors can remain coupled with a particular protective sleeve portion (e.g., sleeves 201 and 202 described with respect to FIG. 2), allowing electrical connections to be made or changed easily while maintaining a protective sleeve for the connection.

In general, a sleeve bore, e.g., bore 108 described with respect to FIG. 1 can be configured to receive inserts that change the shape of the bore. For example, a bore insert can include a tubular member having a hexagonal channel therethrough, along its long axis to accommodate an electrical connector having a hexagonal cross-section. In one embodiment, the bore can be lined with rubber or other materials to provide a desired advantage or use.

A number of illustrative embodiments have been described. Nevertheless, it will be understood that various modifications may be made without departing from the spirit and scope of the various embodiments presented herein. For example, while many of the illustrative embodiments have been described generally in relation to electrical connectors for the heat treating industry, it will be understood that the disclosed sleeves and equivalents thereof can be used in other industrial applications such as welding. In such cases, any dimension of a sleeve, e.g., the interior bore can be modified from that described herein to accommodate camlocks of different size or shape. In related embodiments, setscrews or other fastening devices can be used to secure a sleeve to a camlock instead of using pins, as described herein. Accordingly, other embodiments are within the scope of the following claims.

1. A sleeve for protecting a component of an electrical connector, comprising:
an elongate body formed of a resilient material having an open, interior chamber at a first end defined in part by an interior wall having a cross-sectional diameter selected to frictionally engage the outer surface of an elongate electrical coupler component when inserted into said interior chamber, said elongate electrical coupler having a complimentary diameter and cross-sectional shape about its elongate axis as said chamber, wherein said interior wall inwardly converges to form a constrictive aperture at a second end of said elongate body for engaging an electrically-conductive cable attached to said electrical coupler and minimizing shifting between said cable and said constrictive aperture.

2. The sleeve according to claim 1, wherein the exterior surface of said elongate body has a cross-sectional shape perpendicular to the elongate axis configured to engage a tool for providing mechanical leverage in rotating said sleeve in a desired direction relative to a second, substantially equivalent sleeve.

3. The sleeve according to claim 2, wherein said cross-sectional shape is a hexagon.

4. The sleeve according to claim 1, wherein said resilient material is capable of resisting thermal degradation in temperatures between about 500° F. and about 1000° F. and capable of resisting deformation from manually-applied mechanical forces.

5. The sleeve according to claim 4, wherein said resilient material is Nylon-6,6.

6. The sleeve according to claim 1, further comprising a plurality of bores extending through the cross-sectional diameter of said sleeve that are configured to receive a locking pin of suitable length to span said cross-sectional diameter while passing through a bore of said electrical connector component to prevent translational and rotational shifting of said component within said sleeve.

7. The sleeve according to claim 6, wherein when one bore of said plurality of bores is aligned with said bore of said electrical connector, a first end of said electrical connector is substantially flush with said first end of said sleeve.

8. The sleeve according to claim 1, wherein said electrical connector is a camlock electrical connector.

9. The sleeve according to claim 1, farther comprising a male and female interlocking component extending substantially perpendicularly from a joining face of said sleeve that cooperate to reversibly couple a first said sleeve to a second, different said sleeve.

10. The sleeve according to claim 9, wherein said female interlocking member comprises a cylindrical wall extending from said first end that is configured to receive a male interlocking member comprising a complementary cylindrical wall member; wherein said cylindrical wall of said female interlocking member comprises an integral tongue member that defines a channel for receiving an interlocking post disposed on said cylindrical wall of said male interlocking member.

11. A sleeve for protecting a camlock-type electrical connector, comprising:
first and second elongate sleeve bodies, each comprising a semi-circular channel extending the length of said sleeve body, a locking tab on a first side of said sleeve body, a latch body on a second side of said sleeve body opposite of said locking tab, and a post member extending perpendicularly from said semi-circular channel configured to be inserted into a pin bore of a camlock electrical connector body;
wherein said first and second sleeve bodies are reversibly couplable to form said sleeve by engaging said locking tab on said first sleeve body with said latch body on said second sleeve body and vice-versa, thereby creating a cylindrical bore from each of said semi-circular channels configured to receive said camlock electrical body.

12. The sleeve according to claim 11, wherein said first and said second elongate sleeve bodies are configured substantially identically.

13. The sleeve according to claim 11, wherein the diameter of said cylindrical bore is complementary to the diameter of said camlock electrical connector body.

14. The sleeve according to claim 11, wherein shilling between said camlock electrical connector and said sleeve can be minimized by orienting said camlock in said semi-circular channels of said sleeve bodies such that each of said post member is inserted into opposite sides of said pin bore of said camlock body.

15. The sleeve according to claim 11, wherein when said sleeve is formed by said engaging said first and said second sleeve bodies, said sleeve has a cross-sectional shape perpendicular to the elongate axis configured for engagement with a tool for providing mechanical leverage in rotating said sleeve relative to another of said sleeves.

16. The sleeve according to claim 11, wherein the exterior of said sleeve is smooth along its elongate axis so as to be capable of being pulled over an obstacle or through an aperture without abutment that would prevent further motion in the same direction.

17. The sleeve according to claim 11, wherein said first and second elongate sleeve bodies are formed from a resilient material capable of resisting thermal degradation at temperatures between about 500° F. and about 1000° F. and capable of resisting deformation from mechanical forces.

18. The sleeve according to claim 17, wherein said resilient material is Nylon-6,6.

19. A system for protecting an electrical coupler component, comprising:
first and second reversibly-couplable elongate bodies, each comprising an elongate channel configured to receive a portion of said electrical coupler defined by an interior wall, such that when said first and second elongate bodies are coupled, said channel has a cross-sectional shape perpendicular to the elongate axis of said bodies that is complimentary to the cross-sectional shape of said electrical coupler component; and
one or more recesses in said interior wall configured to receive a terminal end portion of a pin configured to extend through, and protrude from said electrical coupler component on substantially opposite sides for minimizing shilling of said coupler inside said channel when said first and said second bodies are coupled;
wherein each of said bodies comprises a complimentary half of a latch assembly configured to reversibly couple said first and second bodies.

20. The system of claim 19, wherein said electrical coupler component is a cylindrical male or female camlock electrical coupler component.
